(19) United States
(12) Patent Application Publication
(10) Pub. No.: US 2017/0103424 A1
(43) Pub. Date: Apr. 13, 2017

(54) SYSTEMS AND METHODS FOR GENERATING MOOD-BASED ADVERTISEMENTS BASED ON CONSUMER DIAGNOSTIC MEASUREMENTS

(71) Applicant: MASTERCARD INTERNATIONAL INCORPORATED, Purchase, NY (US)

(72) Inventors: Jeremy Pastore, Brooklyn, NY (US); Arun Elangovan, Astoria, NY (US); Michael Zhao, New York, NY (US)

(73) Assignee: MASTERCARD INTERNATIONAL INCORPORATED, Purchase, NY (US)

(21) Appl. No.: 14/881,243

(22) Filed: Oct. 13, 2015

(51) Int. Cl. G06Q 30/02

(52) U.S. Cl. CPC G06Q 30/0269

(57) ABSTRACT

Systems and methods for providing consumers with mood-based advertisements and coupons according to diagnostic measurements are described. A mood of a consumer is determined utilizing diagnostic measurement(s) received through a consumer's portable device. An advertisement or coupon for a product affiliated with a mood correlative with the consumer's mood is selected and transmitted to the consumer's portable consumer device. The mood affiliated with the product of an advertisement or coupon may be based upon historic consumer purchasing.

### FIELD OF TECHNOLOGY

The present disclosure relates generally to advertisement generation or selection, and more particularly to generating or selecting advertisements based on external factors.

### BACKGROUND

Consumers engage merchants on a daily basis to conduct transactions for various types of products. To encourage consumer spending, these merchants disseminate advertisements and coupons for their products amongst consumers, typically on a grand scale. Occasionally, merchants conduct this dissemination of their advertisements and coupons on a limited consumer basis according to socially acknowledged correlations. For example, products such as chips and soda are typically advertised during sporting events, as these products have been socially determined to be relevant to these events.

However, consumer spending involves decisions on an individualized consumer level. During every transaction, the consumer experiences a mood contingent upon various stimuli encountered specifically by the consumer. These moods often have direct impacts on the type of product that may be purchased by the consumer.

### SUMMARY

The present disclosure describes systems and methods for using transducers to collect information relating to consumer mood at pertinent times and providing mood-based advertisements and coupons to consumers based on these diagnostic measurements.

An aspect of the present disclosure relates to a system for providing a consumer with a mood-based advertisement or coupon. The system includes a receiver configured to receive information from transducers providing physiological information to a portable consumer device and is configured to transmit at least an advertisement or a coupon to the portable consumer device. The information received from the portable consumer device includes a diagnostic measurement of a consumer as received from the transducers. The system also includes a diagnostic measurement data warehouse that communicates with the receiver and stores information received from the portable consumer device, including the diagnostic measurement(s). Moreover, the system includes an advertisement/coupon data warehouse that contains advertisements and coupons for products affiliated with various moods correlated to diagnostic measurement(s) received from the transducer(s). Additionally, the system includes a processor that determines a consumer mood using the diagnostic measurement stored in the diagnostic measurement data warehouse. The processor also selects at least an advertisement or a coupon from the advertisement/coupon data warehouse. The selected advertisement and/or coupon is associated with a mood similar to the determined consumer mood based upon the diagnostic measurement. Furthermore, the processor transmits the at least one advertisement or coupon to the receiver.

The information received from the portable consumer device, by the receiver, may include consumer identifying information and/or portable consumer device identifying information. This consumer identifying information and/or portable consumer device identifying information may be used by the receiver when transmitting the at least one advertisement or coupon to the portable consumer device. Further, the diagnostic information as obtained from the transducer(s) may include heart rate, electrocardiogram (“ECG”), blood pressure, voice signature, perspiration, breathing, facial movements, and/or electroencephalography (“EEG”) measurements. The determined consumer mood may be a present consumer mood experienced at the time of a transaction. Moreover, the advertisements and coupons included in the advertisement/coupon data warehouse may be associated with moods determined according to historic consumer transactions, or determined by originators of the advertisements and coupons. Each of the advertisements and coupons included in the advertisement/coupon data warehouse may be associated with at least one mood. Also, the processor may determine the consumer mood using arousal and valence parameters.

Another aspect of the present disclosure relates to a method for providing a consumer with a mood-based advertisement. The method includes receiving identifying information and diagnostic information as obtained from transducer(s) from a portable consumer device, and storing the identifying and diagnostic information in a diagnostic measurement data warehouse. The method also includes determining a mood of the consumer using the received diagnostic information, and selecting an advertisement, from a mood data warehouse, that is associated with the determined mood of the consumer. Moreover, the method includes transmitting the advertisement to the portable consumer device using the received identifying information.

The received identifying information may include consumer identifying information and/or portable consumer device identifying information. The diagnostic information may include heart rate, blood pressure, and/or EEG measurements. Further, the mood associated with the advertisement may be determined by historic consumer purchasing.

A further aspect of the present disclosure relates to a method for providing a consumer with a mood-based coupon. The method includes receiving diagnostic information as collected via certain transducer(s) from a portable consumer device, and storing the diagnostic information in a diagnostic measurement data warehouse. The method further includes determining a present mood of the consumer using the received diagnostic information. The present mood of the consumer is a mood experienced by the consumer substantially contemporaneous with when the diagnostic information is received. Moreover, a coupon affiliated with a mood correlated with the determined present mood of the consumer is selected from a mood data warehouse. Additionally, the coupon is transmitted to the portable consumer device. The method also includes determining whether the coupon is redeemed, and scoring the accuracy of the mood affiliated with the coupon.

The method may further include receiving consumer identifying information and/or portable consumer device identifying information from the portable consumer device. Moreover, the accuracy of the mood associated with the coupon may be scored by determining the proximity between the transmission of the coupon to the portable consumer device and redemption of the coupon. Additionally, the accuracy of the mood associated with the coupon may be scored by determining whether a mood of the consumer experienced substantially contemporaneous with the time when the coupon is redeemed is similar to the determined present mood of the consumer.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference number in different figures indicates similar or identical items or features.

FIG. 1 is an overview block diagram of a system for providing mood-based advertisements and coupons to consumers according to the present disclosure.

FIG. 2 is a block diagram of a system for utilizing diagnostic measurements to provide mood-based advertisements and coupons to consumers according to the present disclosure.

FIG. 3 is a process flow diagram of a method for providing a consumer with a mood-based advertisement according to the present disclosure.

FIG. 4A is a process flow diagram of a method for providing a consumer with a mood-based coupon according to the present disclosure.

FIG. 4B is a process flow diagram of a method for scoring the accuracy of a mood associated with a product of a coupon according to the present disclosure.

FIG. 5A is a graphical depiction of various moods that may be associated with products, advertisements, and coupons according to the present disclosure.

FIG. 5B is a graphical depiction of possible consumer spending analytics corresponding with various consumer moods according to the present disclosure.

FIG. 5C is a graphical depiction of possible consumer spending analytics corresponding with various consumer moods according to the present disclosure.

### DETAILED DESCRIPTION

The detailed description of the present disclosure set forth herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, references to a singular embodiment may include plural embodiments, and references to more than one component may include a singular embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

The present disclosure generally relates to systems and methods for providing mood-based advertisements and coupons to consumers based on diagnostic measurements that evidence consumer mood. For example, electrocardiogram (“ECG”) heart rate data may be used to determine a consumer's mood by analyzing the fluctuation response contained within the ECG heart rate. By quantifying degrees between ECG interbeat interval fluctuation responses, positive and negative inductions in mood may be distinguished. For illustration, mean heart rate remains relatively constant whether a consumer is experiencing a positive or negative mood. However, differences exist between positive and negative moods in relation to frequency components of the heart rate power spectrum. For example, the low frequency component and the high frequency component both increase when a consumer is experiencing a positive mood. The increase in the high frequency component may be attributed to the response of parasympathetic neural enhancement, and the increase in the low frequency component may be attributed to the response of both parasympathetic and sympathetic arousal mechanism. To the contrary, the very low frequency component and the total frequency power both increase when a consumer is experiencing a negative mood. For a given consumer these diagnostic measurements may be correlated to spending patterns and behaviors.

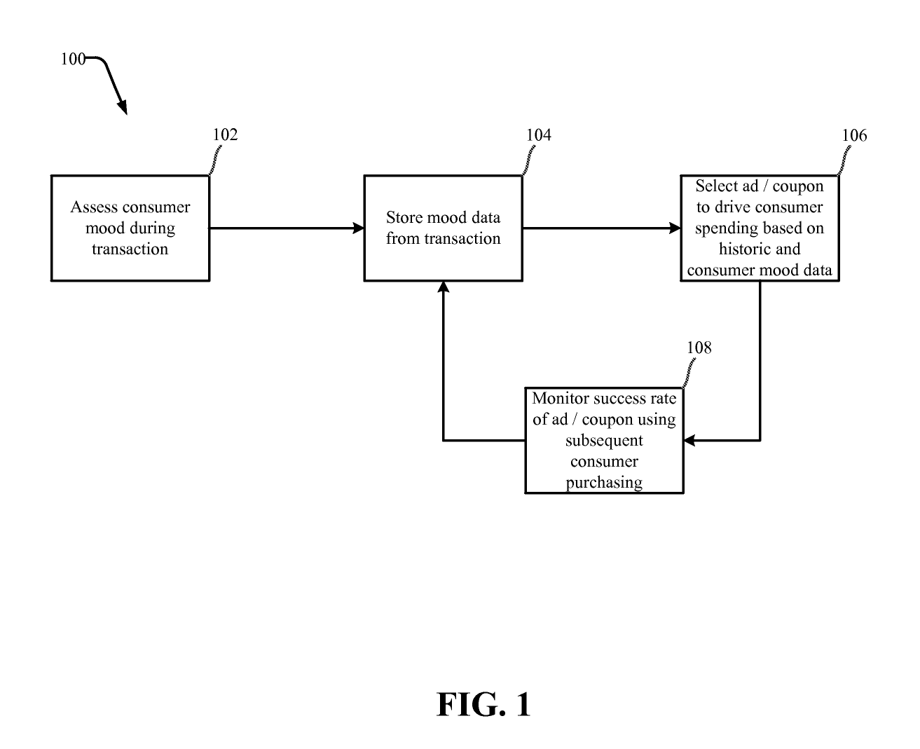

FIG. 1 illustrates an aspect of the present disclosure pertaining to a system 100 for providing mood-based advertisements and coupons to consumers. A consumer's mood is assessed during a transaction between the consumer and a merchant (illustrated as block 102). Such transaction may be face-to-face, i.e., an in-store transaction, or via e-commerce, i.e., a transaction carried out through a merchant website. Assessment of the consumer's mood involves using one or more diagnostic measurements such as, for example, heart rate, ECG, blood pressure, voice signature, perspiration, breathing, facial movements and/or EEG measurements. Each time a consumer conducts a transaction, various information including a consumerID, consumer mood, diagnostic measurements, and transacted product identifying information is stored in a data warehouse (illustrated as block 104). The consumerID may contain consumer identifying information, such as name, address, and the like, as well as portable consumer device (“PCD”) (described in detail below) identifying information, such as a serial number, hardware information, and the like, for example. The consumerID may further contain an “opt-in” disclaimer signifying the consumer's intent to transmit diagnostic measurements and receive mood-based advertisements. This stored information may be partitioned within the data warehouse according to information contained in the consumerID, transacted merchant, and/or product identifying information, for example. Product identifying information may include, for example, product description, price, and stock keeping unit (“SKU”) number. Assessment of the consumer's mood (illustrated as block 102) and storage of the various identifying information (illustrated as block 104) results in a correlated mood being associated with each different product identified in the data warehouse, since each product is associated with the consumer's mood at the time the product was purchased. For example, products may be stored in a table that is accessed by an index representing mood as determined by the diagnostic measurements. Certain indices may provide access to associated products.

At block 106 an advertisement or coupon is selected for the consumer. This involves correlating the consumer's present mood with historic mood data contained within the data warehouse. For example, if the consumer is experiencing an anxious mood, an advertisement or coupon for a product associated with diagnostic measurements indicating an anxious mood according to the historic purchase data should be selected. Selecting an advertisement or coupon associated with the consumer's present mood presents the potential for for increased consumer spending since consumers may be prone to purchase products having a connection to how they are feeling.

At block 108 the success rate of the selected advertisement or coupon is monitored. This may include determining whether the coupon is redeemed within a certain time frame after being generated. This may alternatively include determining whether the coupon is redeemed, e.g., used to conduct a transaction, when the consumer is experiencing a mood similar or identical to a mood associated with the coupon's product. Moreover, this may include monitoring relative overall sales conversion rates compared to presence or absence of the selected ad or different ads. Additionally, this may include establishing a direct link between the PCD's bio-measurement statistics and a virtual wallet. This may further include monitoring voluntary broadcast of bio-measurement statistics at ad receipt by the consumer and/or point-of-sale to a predestinated receiver base. The predestinated receiver base is either embedded in or separate from the point-of-sale terminal.

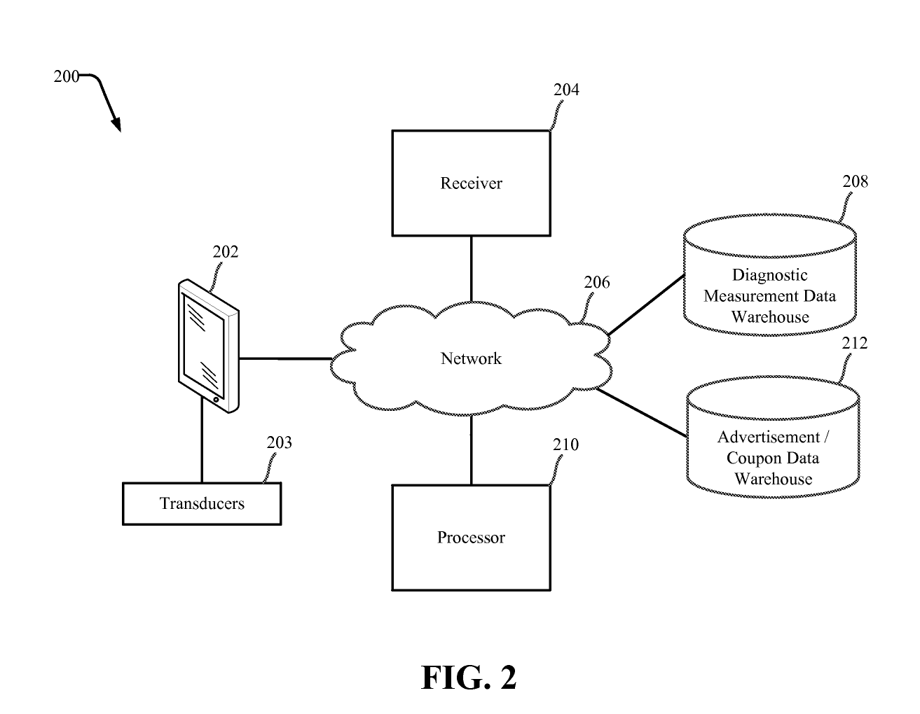

FIG. 2 illustrates a system 200 for monitoring and utilizing diagnostic measurements to provide mood-based advertisements and coupons to consumers according to the present disclosure. The system 200 includes a portable consumer device (“PCD”) 202, one or more transducers 203 may be in communication with or integrated with the PCD 202, a receiver 204, a network 206, a diagnostic measurement data warehouse 208, a processor 210, and an advertisement/coupon data warehouse 212.

The PCD 202 may be any of various devices configured with or in association with transducers 203 to acquire diagnostic measurements from a consumer. This acquisition of diagnostic measurements may occur passively, i.e., the diagnostic measurements are “pushed” from the transducers 203 to the PCD 202, or actively, i.e., the PCD 202 solicits or “pulls” diagnostic measurements from the transducers 203. The PCD 202 may be, for example, a phone, tablet, heart rate monitor, or any of various other devices capable of performing the functions described herein. The transducer(s) may be one or more mechanisms as known in the art for sensing diagnostic measurements. Diagnostic measurements acquired by the PCD 202 include, but are not limited to, heart rate, ECG, blood pressure, voice signature, perspiration, breathing, facial movements, and/or EEG measurements. The PCD 202 is also configured to transmit information to the receiver 204. This information includes the diagnostic measurements acquired from the consumer, as well as identifying information such as consumer identifying information and PCD 202 identifying information, for example. PCD identifying information includes a serial number, hardware information, and the like. Communication between the PCD 202 and the receiver 204 may occur either directly or indirectly via one or more networks (collectively illustrated as network 206) using hardwire, wireless, or Bluetooth means, for example.

The receiver 204 may be any of various devices configured to receive information from the PCD 202. For example, the receiver 204 may be a receiver/transmitter device, such as a low-energy Bluetooth connection to convey messages to/from the PCD, for example iBeacon technology available from Apple, Cupertino, Calif. 95014. Upon receiving information from the PCD 202, the receiver 204 stores the information within a diagnostic measurement data warehouse 208, which may be partitioned according to consumer identifying information or PCD 202 identifying information, for example. As illustrated, the receiver 204 is in indirect communication with the diagnostic measurement data warehouse 208 over the network 206. However, the receiver 204 may be in direct communication with the diagnostic measurement data warehouse 208 without departing from the scope of the present disclosure.

The processor 210 is configured to access the diagnostic measurement data warehouse 208, and is further configured to determine the consumer's present mood using the stored diagnostic measurement. Upon determining the mood of the consumer from the diagnostic measurement, the processor 210 accesses the advertisement/coupon data warehouse 212 and selects an advertisement or coupon associated with a mood similar or identical to the consumer's present mood as determined by the diagnostic measurement information.

The advertisement/coupon data warehouse 212 contains advertisements and coupons for products associated with various moods. Thus, the advertisement/coupon data warehouse 212 may be partitioned according to mood, for example. Moreover, the products indicated in the advertisements and coupons may be correlated to moods determined according to prior consumer transactions of product(s), i.e., consumer mood assessed at a time of particular product purchases, as described in detail herein with respect to FIG. 1. Additionally, mood(s) associated with a given product may be determined/selected by an entity, such as the originator of the advertisement or coupon, for example. Each product indicated within the advertisement/coupon data warehouse 212 may be correlated with a single mood or multiple moods.

As illustrated, the processor 210 is in indirect communication with the diagnostic measurement data warehouse 208 and the advertisement/coupon data warehouse 212 over the network 206. However, it should be appreciated that the processor 210 may be in direct communication with one or both of the data warehouses 208, 212 without departing from the scope of the present disclosure.

Upon selecting an advertisement or coupon from the advertisement/coupon data warehouse 212, the processor 210 transmits the advertisement or coupon to the receiver 204. The receiver 204 is configured to transmit the advertisement or coupon to the PCD 202, where it is displayed to the consumer. In order to ensure the advertisement or coupon is sent to the proper consumer/PCD 202, the receiver 204, in this illustrative embodiment, accesses the diagnostic measurement data warehouse 208 and locates the consumer identifying information and/or PCD 202 identifying information affiliated with the originally received diagnostic measurement. Alternatively, consumer identifying information may be transmitted along with the advertisement or coupon selected as a function of that consumer's mood, to ensure the advertisement or coupon is directed to that consumer's PCD 202.

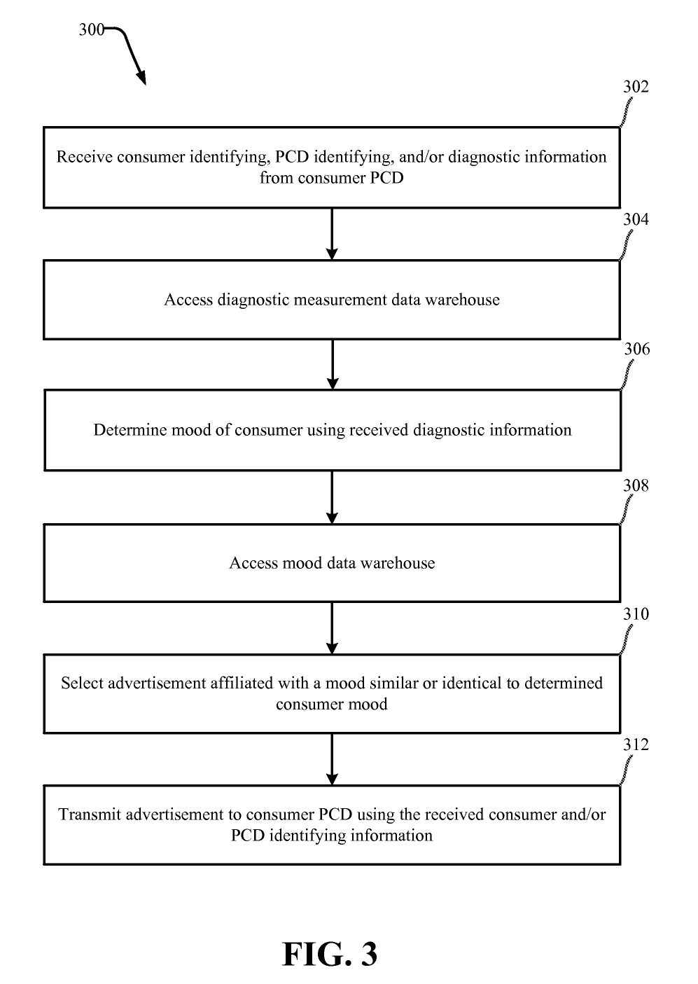

FIG. 3 illustrates a method 300 for providing a consumer with a mood-based advertisement. At block 302 consumer identifying information and/or PCD identifying information, as well as diagnostic information are received from a consumer's PCD. The consumer identifying information may include a consumerID having information specific to the consumer, such as a name, address, email, and the like. The PCD identifying information may include a serial number, hardware information, and the like, for example. The diagnostic information received from the PCD may include, for example, electrocardiogram (“ECG”) heart rate, blood pressure, and/or electroencephalography (“EEG”) data.

At block 304 a diagnostic measurement data warehouse, containing the information received from the PCD, is accessed, and the mood of the consumer is determined using the diagnostic information (illustrated as block 306). At block 308 a mood data warehouse is accessed and an advertisement correlated with a mood similar or identical to the determined present consumer mood, as a function of the consumer's diagnostic information from transducers, is selected (illustrated as block 310). The advertisements contained in the mood data warehouse are correlated with various consumer products. The mood(s) associated with each advertisement may be designated by the originator of the advertisement/product, or may be determined using historic consumer purchasing habits/information, as described in detail herein with respect to FIG. 1. At block 312 the selected advertisement is transmitted to the consumer's PCD using the received identifying information of block 302.

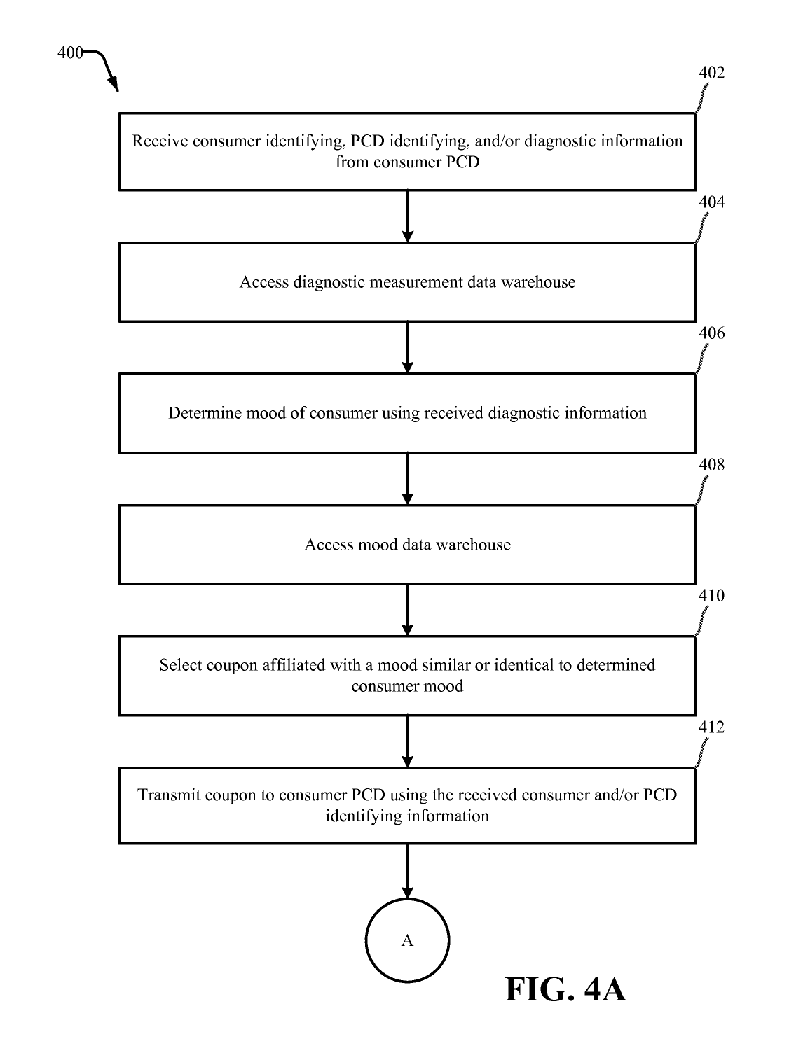

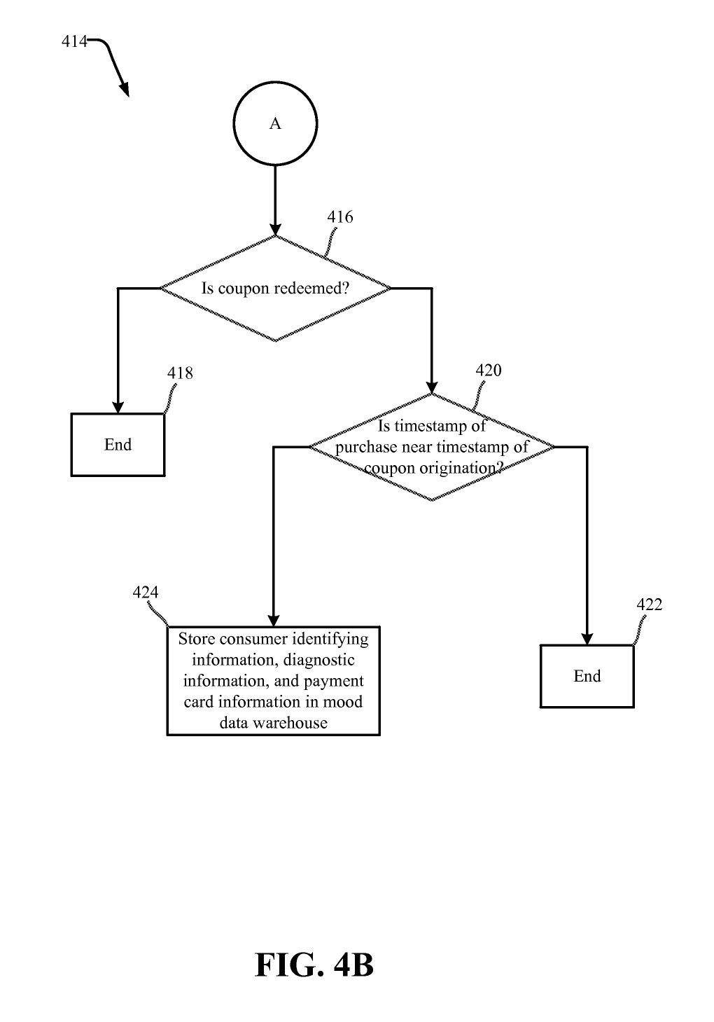

FIG. 4A illustrates a method 400 for providing a consumer with a mood-based coupon. At block 402 consumer identifying information and/or PCD identifying information, as well as diagnostic information are received from a consumer's PCD. The consumer identifying information may include a consumerID having information specific to the consumer, such as a name, address, email, and the like. The PCD identifying information may include a serial number, hardware information, and the like, for example. The diagnostic information received from the PCD may include, for example, electrocardiogram (“ECG”) heart rate, blood pressure, and electroencephalography (“EEG”) data.

At block 404 a diagnostic measurement data warehouse, containing the information received from the PCD, is accessed, and the mood of the consumer is determined using the diagnostic information (illustrated as block 406). At block 408 a mood data warehouse is accessed and a coupon correlated with a mood similar or identical to the determined present consumer mood is selected (illustrated as block 410). The coupons contained in the mood data warehouse are affiliated with various consumer products and as with known coupons they offer incentive(s) to make a purchase, such as a discount, quantity incentive (e.g. 2 for 1 pricing), companion sale items (e.g. buy one item and get a related item free or at a discount), or the like. The mood(s) associated with each coupon may be designated by the originator of the coupon/product, or may be determined using historic consumer purchasing, as described in detail herein with respect to FIG. 1. At block 412 the selected coupon is transmitted to the consumer's PCD using the received identifying information of block 402.

FIG. 4B illustrates a method 414 for scoring (e.g. determining success rate) of the accuracy of the mood associated with the product of the coupon. At decision point 416 it is determined whether the coupon produced from the method 400 is redeemed, i.e., whether a purchase is made using the coupon. The relevant time frame analyzed at decision point 416 is generally between the transmission of the coupon to the consumer's PCD and the expiration date of the coupon. For this determination to occur, unique identifying information that may be tracked may be implemented into the coupon prior to it being transmitted to the consumer. If the coupon's expiration date occurs prior to redemption of the coupon, the method 414 is terminated (illustrated as block 418).

If redemption of the coupon occurs, prior to the expiration of the coupon, it is determined whether the redemption occurred near (temporal proximity to) the timestamp of the transmission of the coupon to the consumer (illustrated as decision point 420). This timeframe may be determined by any relevant party, other than the consumer, and may be any timeframe that occurs prior to the expiration of the coupon. Redemption timing may be used to assess correlative “success” of the coupon offering (e.g. product and/or incentive) to the mood as represented by the diagnostic measurements). For example, the closer to the origination/transmission timestamp that redemption occurs, the greater a propensity score that coupon receives, i.e., the greater likelihood that the mood associated with the coupon/product is correlative.

If the coupon is not redeemed near the timestamp of the coupon's origination, the method 414 is terminated (illustrated as block 422). If, however, the coupon is redeemed/used near the timestamp of the coupon's origination, the consumer identifying information, e.g., consumerID, and the diagnostic information received at block 402, as well as payment card information used during redemption of the coupon are stored in the mood data warehouse (illustrated as block 424).

Alternatively, instead of determining whether the coupon is redeemed within a certain timeframe, it may be determined whether the coupon is redeemed by the consumer while the consumer is experiencing a mood similar or identical to that affiliated with the coupon (not illustrated). This may include accessing the consumer's mood, via diagnostic measurements from relevant sensors or transducers, during redemption of the coupon, and determining whether that mood is similar or identical to the mood affiliated with the coupon.

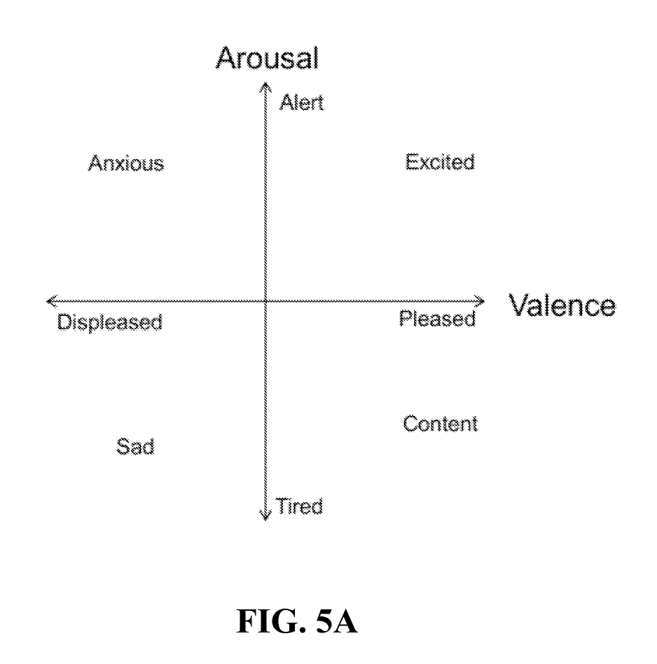

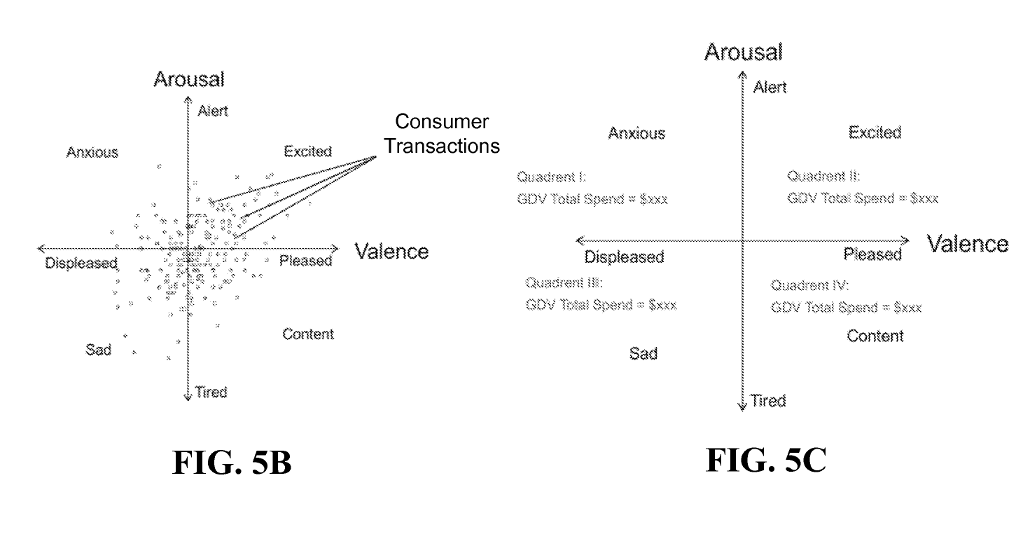

FIG. 5A graphically illustrates various moods that may be associated with products, advertisements, and coupons as disclosed herein. As illustrated, moods may be expressed along arousal and valence dimensions. Arousal, which indicates how awake and reactive to simuli a consumer is, has tired and alert as axial extremities. Valence, which indicates intrinsic attractiveness or aversiveness, has displeased and pleased as its axial extremities. Various moods may be determined according to varying degrees of arousal and valence. For example, an alert arousal and displeased valence results in an anxious mood, an alert arousal and pleased valence results in an excited mood, a tired arousal and pleased valence results in a content mood, and a tired arousal and displeased valence results in a sad mood. Diagnostic measurements from relevant transducers or sensors may be correlated to “moods” along the dimensions illustrated. It should be appreciated that mood as correlated to diagnostic measurements may be expressed in other terms.

FIGS. 5B and 5C graphically illustrate possible consumer spending analytics corresponding with various consumer moods. As previously described with respect to FIG. 1, consumer mood, as a function of diagnostic measurements, may be analyzed at the time of transaction. Thus, consumer transactions may be graphically represented among various moods along arousal and valence axes (illustrated in FIG. 5B). Moreover, provided transaction information, e.g., product price, is gathered along with consumer mood at time of transaction, gross dollar value (“GDV”) of consumer spending may be analyzed for each mood (illustrated in FIG. 5C). Both of the depictions in FIGS. 5B and 5C may allow for merchants to assess their market dominance as compared to other merchants. Furthermore, these graphics may be produced on a consumer level, thereby providing useful data to the consumer showing the consumer or merchant spending behavior according to specific consumer mood.

According to an unillustrated aspect of the present disclosure, analytics based on mood may be provided on a merchant establishment level. Provided that stock keeping unit (“SKU”) level data is either gathered along with consumer mood at time of transaction, or SKU level data is captured within the mood data warehouse described herein, analytics may be provided indicating where in a merchant establishment products, according to their corresponding moods, are located. This may allow merchants to strategically locate products within their store according to mood to drive consumer spending.

The mood-based transactions described herein may be consumated using a “device” or “payment device,” terms used interchangeably herein to describe a card or device that may be presented by an account holder to engage in a transaction either face-to-face or in a remote transaction, such as an e-commerce transaction, telephone transaction, or mail order, for example. Payment devices may be physical cards in the conventional sense, including cards with conventional form factors, smaller or larger cards, cards of different shapes, key fobs, and the like. The cards may include body portions, e.g., laminated plastic layers of a payment card, chip packaging, and the like, memories associated with the body portions, and processors associated with the body portions and coupled to the memories. The memories may contain appropriate applications. The processors may be operative to execute one or more method steps. The applications may be, for example, application identifiers linked to software code in the form of firmware plus data in a card memory such as an electrically erasable programmable read-only memory (EEPROM). Cards may conform to the ISO/IEC 7810 ID-1 format for example (also referred to as “conventional form factor”). However, payment devices, or PCDs, may also represent handheld or other electronic devices that provide the same or similar functionality as described herein.

The computer systems and servers described herein each contain a memory that will configure associated processors to implement methods, steps, and functions described. Such methods, steps, and functions may be carried out, e.g., by processing capability on various system elements or by any combination of elements. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor may retrieve the information from the network.

Accordingly, it will be appreciated that one or more aspects of a system may include a computer program comprising computer program code means adapted to perform one or more steps described when such program is run on a computer, and that such program may be embodied on a tangible computer readable recordable storage medium; for example, in the form of distinct software modules which then execute on one or more hardware processors. Further, a system may include a computer comprising code adapted to cause the computer to carry out one or more steps, together with one or more apparatus elements or features. In various embodiments, software may be implemented in hardware components such as application specific integrated circuits (ASICs). Implementation of a hardware state machine to perform the functions described herein will be apparent to persons skilled in the relevant art(s).

Computers discussed herein may be interconnected, for example, by one or more of network, another virtual private network (VPN), the Internet, a local area and/or wide area network (LAN and/or WAN), via an EDI layer, and so on. The computers may be programmed, for example, in compiled, interpreted, object-oriented, assembly, and/or machine languages, for example, one or more of C, C++, Java, Visual Basic, and the like (an exemplary and non-limiting list), and may also make use of, for example, Extensible Markup Language (XML), known application programs such as relational database applications, spreadsheets, and the like. The computers may be programmed to implement the methods, steps and logic described.

As described herein a network may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse, combinations thereof and/or any suitable communication or data input modality.

Databases or data warehouses discussed herein may include relational, hierarchical, graphical, or object-oriented structure and/or any other database configurations. Moreover, the databases may be organized in any of various suitable manners, for example, as data tables or lookup tables. Each record may be a single file, a series of files, a linked series of data fields or any other data structure. Association of certain data may be accomplished through any desired data association technique such as those known or practiced in the art.

The computers discussed herein may provide a suitable website or other Internet-based graphical user interface which is accessible by users.

As will be appreciated by one of ordinary skill in the art, the improved system described herein may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, may be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, may be implemented by either special purpose hardware-based computer systems which perform the specified functions or steps, or suitable combinations of special purpose hardware and computer instructions.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. It should be appreciated that in the appended claims, reference to an element in the singular is not intended to mean “one and only one” unless explicitly so stated, but rather “one or more.”

Although illustrative embodiments of the present disclosure have been described herein with reference to the accompanying drawings, it is to be understood that the present disclosure is not limited to those precise embodiments, and that various other changes and modifications may be made by one skilled in the art without departing from the scope or spirit of the disclosure.

What is claimed is:

1. A system for providing a consumer with a mood-based advertisement or coupon comprising:
a receiver configured to receive information from a portable consumer device, the information including a diagnostic measurement, the receiver further configured to transmit at least one advertisement or coupon to the portable consumer device;
a diagnostic measurement data warehouse in communication with the receiver and including the information received from the portable consumer device;
an advertisement/coupon data warehouse including advertisements and coupons for products affiliated with various moods; and
a processor configured to determine a consumer mood using the diagnostic measurement stored in the diagnostic measurement data warehouse, the processor further configured to select the at least one advertisement or coupon from the advertisement/coupon data warehouse, the at least one advertisement or coupon being for a product affiliated with a mood similar to the determined consumer mood, the processor further configured to transmit the at least one advertisement or coupon to the receiver.

2. The system of claim 1 wherein the information received from the portable consumer device further includes at least one of consumer identifying information and portable consumer device identifying information.

3. The system of claim 2 wherein the receiver transmits the at least one advertisement or coupon to the portable consumer device using the at least one of consumer identifying information and portable consumer device identifying information.

4. The system of claim 1 further including at least one sensor to obtain the diagnostic measurement and wherein the diagnostic information includes at least one of heart rate, blood pressure, electrocardiogram (ECG), voice signature, perspiration, breathing, facial movement and electroencephalogram (EEG).

5. The system of claim 1 wherein the determined consumer mood is a present consumer mood at the time of a transaction.

6. The system of claim 1 wherein the advertisements and coupons included in the advertisement/coupon data warehouse are stored in association with moods determined according to historic consumer transactions.

7. The system of claim 1 wherein the advertisements and coupons included in the advertisement/coupon data warehouse are stored in association with moods determined by originators of the advertisements and coupons.

8. The system of claim 1 wherein each of the advertisements and coupons included in the advertisement/coupon data warehouse are affiliated with at least one mood.

9. The system of claim 1 wherein the processor determines the consumer mood using arousal and valence parameters.

10. A method for providing a consumer with a mood-based advertisement comprising the steps of:
receiving identifying information and diagnostic information from a portable consumer device;
storing the identifying information and diagnostic information in a diagnostic measurement data warehouse;
determining a mood of the consumer using the received diagnostic information;
selecting an advertisement from a mood data warehouse, the advertisement being affiliated with a mood correlative with the determined mood of the consumer; and
transmitting the advertisement to the portable consumer device using the received identifying information.

11. The method of claim 10 wherein the identifying information includes at least one of consumer identifying information and portable consumer device identifying information.

12. The method of claim 10 wherein the diagnostic information includes at least one of heart rate, blood pressure, electrocardiogram (ECG), voice signature, perspiration, breathing, facial movement and electroencephalogram (EEG).

13. The method of claim 10 wherein the mood affiliated with the advertisement is determined based on historic consumer purchasing.

14. A method for providing a consumer with a mood-based coupon comprising the steps of:
receiving diagnostic information from a portable consumer device;
storing the diagnostic information in a diagnostic measurement data warehouse;
determining a present mood of the consumer using the received diagnostic information, the present mood of the consumer being a mood experienced by the consumer when the diagnostic information is received;
selecting a coupon from a mood data warehouse, the coupon being affiliated with a mood correlative with the determined present mood of the consumer;
transmitting the coupon to the portable consumer device; and
determining whether the coupon is redeemed.

15. The method of claim 14 further comprising the step of:
receiving at least one of consumer identifying information and portable consumer device identifying information from the portable consumer device.

16. The method of claim 14 wherein the scoring step includes determining the proximity between the transmission of the coupon to the portable consumer device and redemption of the coupon.

17. The method of claim 14 wherein the scoring step includes determining whether a mood of the consumer experienced when the coupon is redeemed is similar to the determined present mood of the consumer.

18. The method of claim 14 wherein the step of receiving diagnostic information from a portable consumer device involves receiving diagnostic information from at least one transducer in the portable consumer device.

19. The method of claim 14 wherein the diagnostic information includes at least one of heart rate, blood pressure, electrocardiogram (ECG), voice signature, perspiration, breathing, facial movement and electroencephalogram (EEG).

20. The method of claim 14 wherein the diagnostic information includes at least one of heart rate, blood pressure, electrocardiogram (ECG), voice signature, perspiration, breathing, facial movement and electroencephalogram (EEG).

21. The method of claim 14 further including the steps of scoring the accuracy of the mood affiliated with the coupon.
